(19) United States
(12) Patent Application Publication
(10) Pub. No.: US 2026/0235925 A1
(43) Pub. Date: Aug. 13, 2026

(54) CAMERA MODULE

(71) Applicant: SAMSUNG ELECTRO-MECHANICS CO., LTD., Suwon-si (KR)

(72) Inventors: Hyun Jun KIM, Suwon-si (KR); Young Bok YOON, Suwon-si (KR); Hong Joo LEE, Suwon-si (KR); Nam Ki PARK, Suwon-si (KR); Kyung Hun LEE, Suwon-si (KR); Soo Cheol LIM, Suwon-si (KR)

(73) Assignee: SAMSUNG ELECTRO-MECHANICS CO., LTD., Suwon-si (KR)

(21) Appl. No.: 19/266,549

(22) Filed: Jul. 11, 2025

(30) Foreign Application Priority Data
Feb. 7, 2025 (KR) 10-2025-0016098

(51) Int. Cl. G03B 5/00; G02B 27/64; H01F 7/08

(52) U.S. Cl. CPC G03B 5/00; G02B 27/646; H01F 7/081; G03B 2205/0007; G03B 2205/0069

(57) ABSTRACT

A camera module includes a housing, a lens module accommodated in the housing and including a plurality of lenses arranged in an optical axis direction, and an image stabilization actuator including a magnet and a coil disposed to face each other and configured to provide driving force to move the lens module in a direction perpendicular to an optical axis. The magnet includes a first sub-magnet, a second sub-magnet, and a third sub-magnet disposed in sequence in a short axis direction of the coil and having different magnetization directions.

### CROSS-REFERENCE TO RELATED APPLICATIONS

This application claims the benefit under 35 USC 119(a) of Korean Patent Application No. 10-2025-0016098 filed on Feb. 7, 2025, in the Korean Intellectual Property Office, the entire disclosure of which is incorporated herein by reference for all purposes.

### BACKGROUND

### Field

The present disclosure relates to a camera module, and more particularly, to a camera module characterized by an image stabilization actuator.

### Description of the Background

Camera modules mounted on portable electronic devices such as smartphones have autofocus and image stabilization functions, and such camera modules are equipped with actuators implementing these functions.

Among various types of actuators, a Voice Coil Motor (VCM) actuator has the advantage of being simple in structure and having ease of miniaturization because it generates driving force using magnets and coils, but has the problem that a magnetic field thereof, leaking to the opposite side of the coil when the driving force is generated reduces the driving efficiency.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing, a lens module accommodated in the housing and including a plurality of lenses arranged in an optical axis direction, and an image stabilization actuator including a magnet and a coil disposed to face each other and configured to provide driving force to move the lens module in a direction perpendicular to an optical axis. The magnet includes a first sub-magnet, a second sub-magnet, and a third sub-magnet disposed in sequence in a short axis direction of the coil and having different magnetization directions.

The second sub-magnet may have a magnetization direction parallel to a direction facing the coil, and the first sub-magnet and the third sub-magnet disposed on one side and the other side of the second sub-magnet based on the short axis direction of the coil may have a magnetization direction parallel to the short axis direction of the coil.

The magnet may further include a fourth sub-magnet disposed on a side of the first sub-magnet and a fifth sub-magnet disposed on a side of the third sub-magnet in the short axis direction of the coil, wherein the fourth sub-magnet and the fifth sub-magnet may have a magnetization direction parallel to the direction facing the coil.

The fourth sub-magnet and the fifth sub-magnet may have magnetization directions opposite to that of the second sub-magnet.

The second sub-magnet may be longer than the first sub-magnet and the third sub-magnet in the short axis direction of the coil.

The magnet may further include a 1-1 sub-magnet, a 2-1 sub-magnet, and a 3-1 sub-magnet sequentially disposed on both sides of the first sub-magnet, the second sub-magnet, and the third sub-magnet in a longitudinal axis direction of the coil and may have different magnetization directions.

The first sub-magnet, the second sub-magnet, and the third sub-magnet may have lengths in the longitudinal axis direction of the coil, and the 1-1 sub-magnet, the 2-1 sub-magnet, and the 3-1 sub-magnet may have lengths in the short axis direction of the coil.

The 2-1 sub-magnet may have a magnetization direction parallel to the direction facing the coil, and the 1-1 sub-magnet and the 3-1 sub-magnet disposed on one side and the other side of the 2-1 sub-magnet based on the longitudinal axis direction of the coil may have magnetization directions parallel to the longitudinal axis direction of the coil.

A surface of the magnet facing the coil may include a first portion disposed on one side based on a boundary and a second portion disposed on the other side, and the coil may include a plurality of coils facing the first portion and the second portion, respectively.

The first portion and the second portion may include the first sub-magnet, the second sub-magnet, and the third sub-magnet, the first sub-magnet, the second sub-magnet and the third sub-magnet of the first portion may have magnetization directions opposite to those of the first sub-magnet, the second sub-magnet, and the third sub-magnet of the second portion.

The camera module may further include a back yoke disposed on an opposite side to the coil based on the magnet.

The magnet may be disposed on the lens module, and the coil may be disposed on the housing.

The camera module may further include a carrier accommodated in the housing and accommodating the lens module, a ball member disposed between the lens module and the carrier, and guiding movement of the lens module, and a pulling yoke disposed on the carrier to face the magnet in the optical axis direction.

The lens module may include a lens barrel having the plurality of lenses, and a lens holder to which the lens barrel is coupled and on which the magnet is disposed.

The image stabilization actuator may include a first image stabilization actuator configured to provide a driving force to move the lens module in a first direction and a second image stabilization actuator configured to provide a driving force to move the lens module in a second direction, perpendicular to the first direction, and the first image stabilization actuator and the second image stabilization actuator may be perpendicularly disposed to each other.

Other features and aspects will be apparent from the following detailed description, the drawings, and the claims.

### BRIEF DESCRIPTION OF DRAWINGS

FIG. 1 is a perspective view of a camera module according to an embodiment.

FIG. 2 is an exploded perspective view of a camera module according to an embodiment.

FIG. 3 is a cross-sectional view taken along line I-I’ of FIG. 1.

FIG. 4 is a perspective view of an image stabilization actuator according to a first embodiment.

FIG. 5 is a side view of an image stabilization actuator according to the first embodiment.

FIG. 6 is a side view of an image stabilization actuator according to a modified first embodiment.

FIG. 7 is a perspective view of an image stabilization actuator according to a second embodiment.

FIG. 8 is a side view of an image stabilization actuator according to the second embodiment.

FIG. 9 is a perspective view of an image stabilization actuator according to a third embodiment.

FIG. 10 is a perspective view of an image stabilization actuator according to a fourth embodiment.

FIGS. 11A and 11B illustrate magnetic fluxes formed by image stabilization actuators according to the embodiments of FIGS. 4 and 7, respectively.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being "on," "connected to," or "coupled to" another element, it may be directly "on," "connected to," or "coupled to" the other element, or there may be one or more other elements intervening therebetween. In contrast, when an element is described as being "directly on," "directly connected to," or "directly coupled to" another element, there can be no other elements intervening therebetween.

As used herein, the term "and/or" includes any one and any combination of any two or more of the associated listed items; likewise, "at least one of" includes any one and any combination of any two or more of the associated listed items.

Although terms such as "first," "second," and "third" may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as "above," "upper," "below," "lower," and the like, may be used herein for ease of description to describe one element’s relationship to another element as shown in the figures. Such spatially relative terms are intended to encompass different orientations of the device in use or operation in addition to the orientation depicted in the figures. For example, if the device in the figures is turned over, an element described as being "above," or "upper" relative to another element would then be "below," or "lower" relative to the other element. Thus, the term "above" encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles "a," "an," and "the" are intended to include the plural forms as well, unless the context clearly indicates otherwise. The terms "comprises," "includes," and "has" specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term "may" with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure relates to an image stabilization actuator and a camera module including the same. The camera module according to the embodiment may be applied to portable electronic devices such as mobile communication terminals, smartphones, and tablet PCs.

An aspect of the present disclosure is to provide an image stabilization actuator in which driving sensitivity may be improved and miniaturization may be obtained, and a camera module including the same.

The camera module is an optical device for taking pictures or videos, and includes a lens that refracts light reflected from a subject and a lens driving device that moves the lens to adjust focus or correct shake.

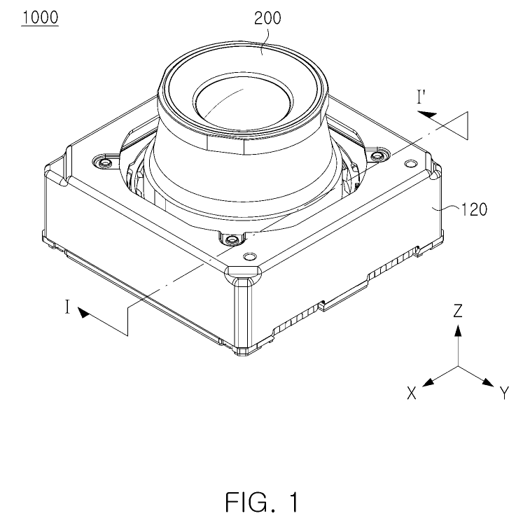

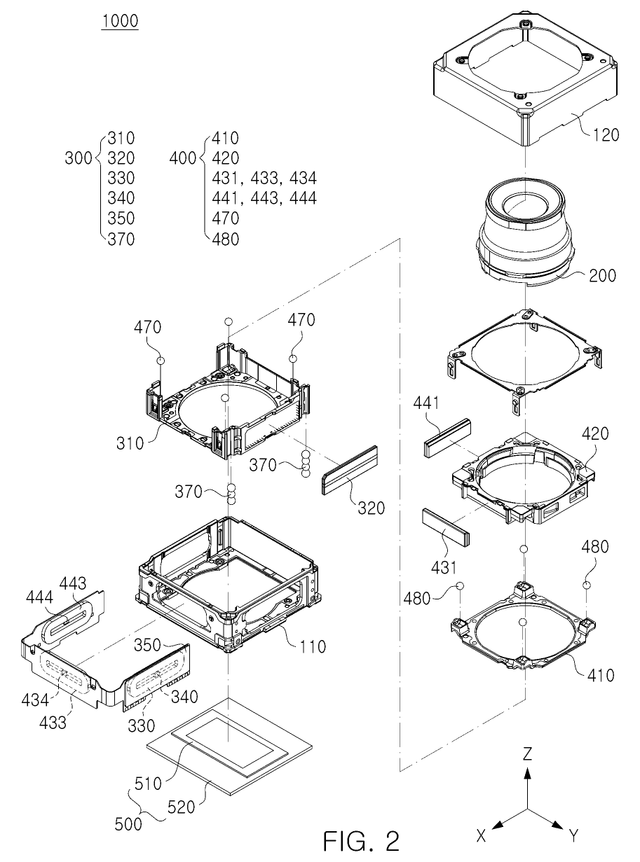

FIG. 1 is a perspective view of a camera module according to an embodiment, and FIG. 2 is an exploded perspective view of a camera module according to an embodiment.

Referring to FIGS. 1 and 2 , a camera module 1000 according to an embodiment includes a lens barrel 200, lens driving units 300 and 400 driving the lens barrel 200, an image sensor module 500 converting light incident through the lens barrel 200 into an electric signal, and a housing 110 and a case 120 accommodating the lens barrel 200 and the lens driving units 300 and 400.

The lens barrel 200 may have a hollow cylindrical shape so that a plurality of lenses for capturing a subject may be accommodated therein, and the plurality of lenses are mounted in the lens barrel 200 along an optical axis. In this specification, the optical axis is parallel to the Z-axis direction, and the optical axis direction or the direction parallel to the optical axis refers to the Z-axis direction. A plurality of lenses are disposed in a required number, and respective lenses may have the same or different optical characteristics.

The image sensor unit 500 is a device that converts light incident through the lens barrel 200 into an electric signal. For example, the image sensor unit 500 includes an image sensor 510 and a printed circuit board 520 on which the image sensor 510 is mounted, and may further include an infrared filter. The infrared filter serves to block light in the infrared region from the light incident through the lens barrel 200.

The image sensor 510 converts light incident through the lens barrel 200 into an electric signal. For example, the image sensor 510 may be a Charge Coupled Device (CCD) or a Complementary Metal-Oxide Semiconductor (CMOS). The image sensor 510 is mounted on a printed circuit board 520 and may be electrically connected to the printed circuit board 520 through wire bonding. The electric signal converted by the image sensor 510 is output through a display of a portable electronic device.

The lens driving units 300 and 400 may be configured to move the lens barrel 200 relative to the housing 110. The lens driving units 300 and 400 may include a focusing drive unit 300 that moves the lens barrel 200 in the direction of the optical axis (Z-axis) to adjust the focus, and an image stabilization drive unit 400 that moves the lens barrel 200 in a direction perpendicular to the optical axis (Z-axis) to correct shake during shooting.

The case 120 may be coupled to the housing 110 and may have a function of protecting components of the camera module 1000.

In addition, the case 120 may have a function of shielding electromagnetic waves. For example, the case 120 may shield electromagnetic waves so that electromagnetic waves generated from the camera module 1000 do not affect other electronic components mounted on the portable electronic device. Similarly, the case 120 may shield electromagnetic waves so that electromagnetic waves generated from other electronic components mounted on the portable electronic device do not affect the camera module 1000. To this end, the case 120 may be provided with a metal material and may be grounded to a ground pad provided on the printed circuit board 520.

The focusing drive unit 300 may be configured to move the lens barrel 200 in a direction parallel to the optical axis (Z-axis). In an embodiment, the focusing drive unit 300 includes a carrier 310 accommodating a lens barrel 200 and a focusing actuator generating driving force to move the lens barrel 200 and the carrier 310 in the direction of the optical axis (Z-axis).

In an embodiment, the focusing actuator is a voice coil motor and may include a magnet 320 and a coil 330. As an example, the magnet 320 may be mounted on the carrier 310 and the coil 330 may be mounted on the housing 110. The magnet 320 is a movable member that is mounted on the carrier 310 and moves in the direction of the optical axis (Z-axis) together with the carrier 310, and the coil 330 is a fixed member that is mounted on the housing 110. However, this is not limited thereto, and the positions of the magnet 320 and the coil 330 may be exchanged.

When current is applied to the coil 330, the carrier 310 may be moved in the direction of the optical axis (Z-axis) by the electromagnetic influence between the magnet 320 and the coil 330. Since the lens barrel 200 is accommodated in the carrier 310, the lens barrel 200 also moves in the direction of the optical axis (Z-axis) by the movement of the carrier 310.

When the carrier 310 is moved, a rolling member 370 may be disposed between the carrier 310 and the housing 110 to reduce friction between the carrier 310 and the housing 110. The rolling member 370 may be in the shape of a ball. The rolling member 370 may be disposed on both sides of the length direction of the magnet 320.

A first yoke 350 may be disposed in the housing 110. The first yoke 350 may be disposed so as to face the magnet 320 and generate an attractive force with the magnet 320. For example, the first yoke 350 may face the magnet 320 in a direction perpendicular to the optical axis (Z-axis) and generate an attractive force in the facing direction. The rolling member 370 may not be detached while maintaining contact with the carrier 310 and the housing 110 by the magnetic attractive force between the first yoke 350 and the magnet 320.

In addition, a position sensor 340 that detects the position of the lens barrel 200 may be disposed in the housing 110. The position sensor 340 may be disposed so as to face the magnet 320 and may be provided with, for example, a hall sensor.

Meanwhile, the focusing drive unit 300 is not limited to the embodiment described above. For example, some components may be omitted or other components may be added in the focusing drive unit 300 described herein.

The image stabilization drive unit 400 is used to correct blurring of an image or shaking of a video due to a user's hand shaking, or the like when taking an image or video. For example, when shaking occurs during taking an image or video, the image stabilization drive unit 400 compensates for the shaking by providing a relative displacement corresponding to the shaking to the lens barrel 200, in detail, a lens module, which may include the lens barrel 200 and a lens holder 420 described below.

The image stabilization drive unit 400 may be configured to move the lens barrel 200 on a plane perpendicular to the optical axis (Z-axis). For example, the image stabilization drive unit 400 may move the lens barrel 200 in two axial directions perpendicular to and intersecting with the optical axis (Z-axis), for example, in the first axis (X-axis) and the second axis (Y-axis) directions.

The image stabilization drive unit 400 includes a first image stabilization actuator that generates a driving force to move the lens barrel 200 in the first direction (X-direction) and a second image stabilization actuator that generates a driving force to move the lens barrel 200 in the second direction (Y-direction).

In an embodiment, the first and second image stabilization actuators are voice coil motors and may include magnets 431 and 441 and coils 433 and 443. For example, the magnets 431 and 441 may be mounted on the lens holder 420, and the coils 433 and 443 may be mounted on the housing 110. The magnets 431 and 441 are movable members that are mounted on the lens holder 420 and move in a direction perpendicular to the optical axis (Z-axis) together with the lens holder 420, and the coils 433 and 443 are fixed members mounted on the housing 110. However, the present disclosure is not limited thereto, and the positions of the magnets 431 and 441 and the coils 433 and 443 may be exchanged.

When current is applied to the coils 433 and 443, the lens holder 420 may be moved in a direction perpendicular to the optical axis (Z-axis) by the electromagnetic influence between the magnets 431 and 441 and the coils 433 and 443.

The image stabilization drive unit 400 may include ball members that smooth the movement of the lens holder 420, and the like. The image stabilization drive unit 400 may include a frame 410 accommodated in a carrier 310 and a lens holder 420 accommodated in the frame 410. The ball members may be disposed between the carrier 310 and the frame 410, and between the frame 410 and the lens holder 420. The ball members may support the movement of the frame 410 and the lens holder 420, guide the direction of movement, and maintain gaps between the carrier 310, the frame 410, and the lens holder 420.

In an embodiment, the ball members may include a first ball member 470 disposed between the carrier 310 and the frame 410 and a second ball member 480 disposed between the frame 410 and the lens holder 420. The first ball member 470 may guide movement in the first direction (X-direction) during image stabilization, and the second ball member 480 may guide movement in the second direction (Y-direction) during image stabilization.

The carrier 310 and the frame 410 may include a first guide groove that accommodates the first ball member 470, on surfaces thereof facing each other in the optical axis (Z-direction). For example, the first guide groove may extend in the first direction (X-direction) and limit the movement direction of the first ball member 470 to the first direction (X-direction).

In addition, the frame 410 and the lens holder 420 may include a second guide groove that accommodates the second ball member 480, on surfaces thereof facing each other in the optical axis (Z-direction). For example, the second guide groove may extend in the second direction (Y-direction) and limit the movement direction of the second ball member 480 to the second direction (Y-direction).

Although not illustrated in the drawing, in another embodiment, the frame 410 may be omitted, and the carrier 310 may accommodate a lens holder 420. Ball members may be disposed between the carrier 310 and the lens holder 420, and the ball members may guide both the first direction (X-direction) and the second direction (Y-direction) movement of the lens holder 420.

A second yoke (or pulling yoke) 450 may be disposed in the carrier 310. The second yoke 450 may be disposed so as to face the magnets 431 and 441 and generate an attractive force with the magnets 431 and 441. For example, the second yoke 450 may face the magnets 431 and 441 in the optical axis (Z-axis) direction and generate an attractive force in the facing direction. The first ball member 470 and the second ball member 480 may not be separated while maintaining contact with the carrier 310, the frame 410, and the lens holder 420 due to the magnetic attraction between the second yoke 450 and the magnets 431 and 441.

In addition, position sensors 434 and 444 that detect the position of the lens barrel 200 may be disposed in the housing 110. The position sensors 434 and 444 may be disposed facing the magnets 431 and 441, and may be provided as hall sensors, for example. The position sensors 434 and 444 may be disposed on the inner sides of the coils 433 and 443, and may face portions of the second sub-magnets 431b and 441b of the magnets 431 and 441, which will be described later.

Meanwhile, the image stabilization drive unit 400 is not limited to the embodiment described above. For example, some components may be omitted or other components may be added in the image stabilization drive unit (hereinafter, image stabilization actuator) 400 described in this specification.

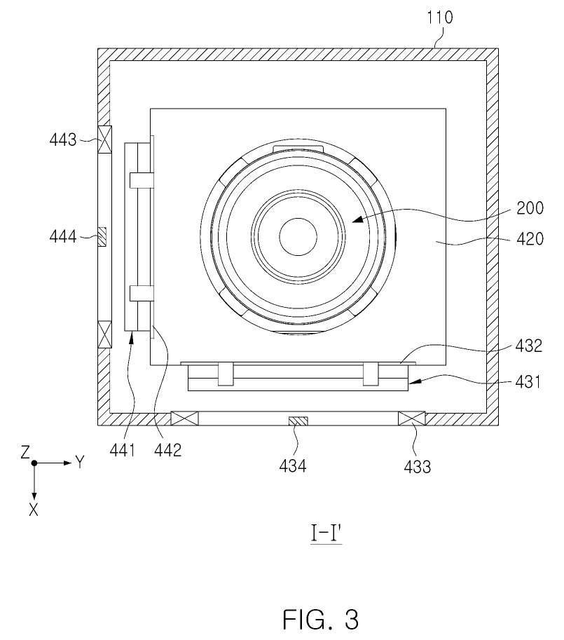

FIG. 3 is a cross-sectional view taken along line I-I of FIG. 1.

Referring to FIG. 3, the first image stabilization actuator may include a first voice coil motor disposed on one side, and the second image stabilization actuator may include a second voice coil motor disposed on the other side. The first voice coil motor and the second voice coil motor may be disposed perpendicular to each other.

In an embodiment, the first voice coil motor may include a first magnet 431 and a first coil 433 facing in a first direction (X-direction), and the second voice coil motor may include a second magnet 441 and a second coil 443 facing in a second direction (Y-direction). The first magnet 431 and the second magnet 441 may be disposed in the lens holder 420, and the first coil 433 and the second coil 443 may be disposed in the housing 110.

Back yokes 432 and 442 may be disposed between the lens holder 420 and the magnets 431 and 441. For example, the back yokes 432 and 442 may be members inserted into the lens holder 420 and may include a magnetic material. The back yokes 432 and 442 may be disposed on the opposite side of the magnets 431 and 441 from the reference coils 433 and 443 to prevent leakage of the magnetic field.

According to embodiments, the first magnet 431 and the second magnet 441 may be provided as multipolar magnets. The first magnet 431 and the second magnet 441 may include a plurality of sub-magnets having different magnetization directions. According to embodiments, the magnetic field formed by the plurality of sub-magnets may be concentrated between the first and second magnets 431 and 441 and the first and second coils 433 and 443.

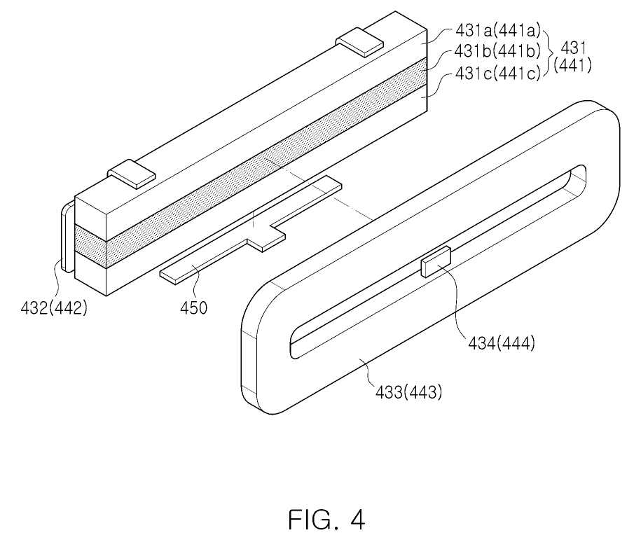

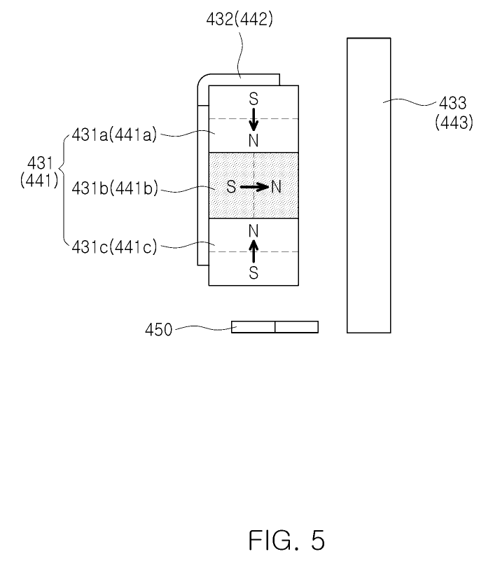

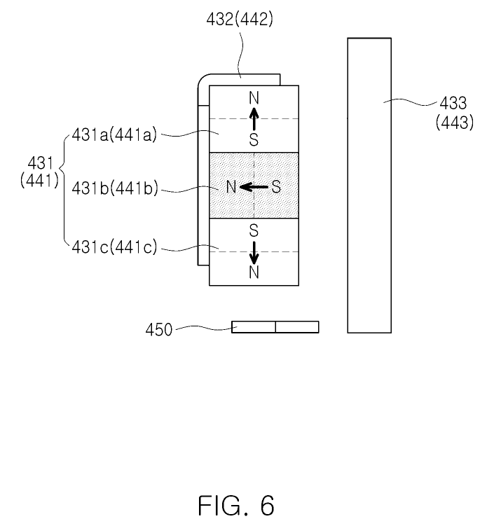

FIG. 4 is a perspective view of an image stabilization actuator according to a first embodiment, FIG. 5 is a side view of an image stabilization actuator according to the first embodiment, and FIG. 6 is a side view of an image stabilization actuator according to a modified first embodiment.

Referring to FIG. 4, the first magnet 431 and the second magnet 441 may each include three sub-magnets divided in the longitudinal axis (length) direction of the first coil 433 and the second coil 443. For example, the first magnet 431 and the second magnet 441 may include the first sub-magnets 431a and 441a, the second sub-magnets 431b and 441b, and the third sub-magnets 431c and 441c.

The first to third sub-magnets 431a, 431b, 431c, 441a, 441b, and 441c may be sequentially disposed in the short axis (height) direction of the first coil 433 and the second coil 443, and may be provided as one unit. For example, the second sub-magnets 431b and 441b may be positioned at the center of the first magnet 431 and the second magnet 441, and the first sub-magnets 431a and 441a and the third sub-magnets 431c and 441c, which are disposed above and below the second sub-magnets 431b and 441b, may be positioned in upper and lower portions of the first magnet 431 and the second magnet 441, respectively.

In an embodiment, the magnetization directions of the first to third sub-magnets 431a, 431b, 431c, 441a, 441b, and 441c may be different from each other.

The second sub-magnets 431b and 441b may be magnetized in a direction perpendicular to one surface of the first and second coils 433 and 443 facing the first and second magnets 431 and 441 (or in a direction in which the first and second magnets 431 and 441 and the first and second coils 433 and 443 face each other). For example, referring to FIG. 5, the second sub-magnets 431b and 441b may have an S-pole on one surfaces thereof facing the back yokes 432 and 442 and an N-pole on one surfaces thereof facing the first and second coils 433 and 443.

The first sub-magnets 431a and 441a and the third sub-magnets 431c and 441c may be magnetized in a direction parallel to one side of the first and second coils 433 and 443 facing the first and second magnets 431 and 441, for example, in the short axis direction of the first and second coils 433 and 443. At this time, the magnetization direction of the first sub-magnets 431a and 441a and the magnetization direction of the third sub-magnets 431c and 441c may be opposite to each other. For example, referring to FIG. 5, the first sub-magnets 431a and 441a may have S-poles and N-poles arranged vertically, and the third sub-magnets 431c and 441c may have N-poles and S-poles arranged vertically.

According to an embodiment, the first to third sub-magnets 431a, 431b, 431c, 441a, 441b, and 441c may interact with each other to form a strong magnetic field. For example, the first sub-magnets 431a and 441a and the second sub-magnets 431b and 441b, the second sub-magnets 431b and 441b, and the third sub-magnets 431c and 441c respectively form a closed curve, and may increase the magnetic flux density inside the first and second magnets 431 and 441. In addition, when current is applied to the first and second coils 433 and 443, a magnetic field (magnetic flux) is concentrated between the first and second magnets 431 and 441 and the first and second coils 433 and 443, and a magnetic field leaking in the opposite direction may be significantly reduced. Therefore, according to an embodiment, since there is almost no magnetic field leaking to the opposite side of the first and second coils 433 and 443, the back yokes 432 and 442 illustrated in FIGS. 4 and 5 may be omitted.

Meanwhile, in the embodiment, the first to third sub-magnets 431a, 431b, 431c, 441a, 441b, and 441c may be manufactured to have approximately the same size. For example, the first to third sub-magnets 431a, 431b, 431c, 441a, 441b, and 441c may have approximately the same length in the longitudinal axis and short axis directions of the first and second coils 433 and 443. Accordingly, the ratios of the first to third sub-magnets 431a, 431b, 431c, 441a, 441b, and 441c on one side of the first and second magnets 431 and 441 facing the first and second coils 433 and 443 may be approximately the same.

Alternatively, the second sub-magnets 431b and 441b may be manufactured to have a larger size than the first and third sub-magnets 431a, 431c, 441a and 441c. For example, the second sub-magnets 431b and 441b may be formed to have approximately the same length as the first and third sub-magnets 431a, 431c, 441a and 441c in the longitudinal axis direction of the first and second coils 433 and 443 while being longer than the first and third sub-magnets 431a, 431c, 441a and 441c in the short axis direction. For example, the ratio of the second sub-magnets 431b and 441b on one side of the first and second magnets 431 and 441 facing the first and second coils 433 and 443 is the largest, and the first and third sub-magnets 431a, 431c, 441a and 441c may be approximately equal.

When the first to third sub-magnets 431a, 431b, 431c, 441a, 441b, and 441c satisfy the conditions described above, the magnetic field sensitivity may be improved, and this is equally applied to the embodiments described below.

Meanwhile, the magnetization direction of the first to third sub-magnets 431a, 431b, 431c, 441a, 441b, and 441c may be changed. Referring to FIG. 6, the first to third sub-magnets 431a, 431b, 431c, 441a, 441b, and 441c may be magnetized in directions opposite to those of FIGS. 4 and 5.

For example, referring to FIG. 6, the second sub-magnets 431b and 441b may be provided with an N-pole on one surfaces thereof facing the back yokes 432 and 442 and an S-pole on one side facing the first and second coils 433 and 443. In addition, the first sub-magnets 431a and 441b may be provided with an N-pole and an S-pole upwards and downwards, and the third sub-magnets 431c and 441c may be provided with an S-pole and an N-pole upwards and downwards.

In the case of the embodiment of FIG. 6, the magnetic flux may be concentrated between the first and second magnets 431 and 441 and the first and second coils 433 and 443, and the same effect as the embodiment according to FIG. 4 and the like may be obtained.

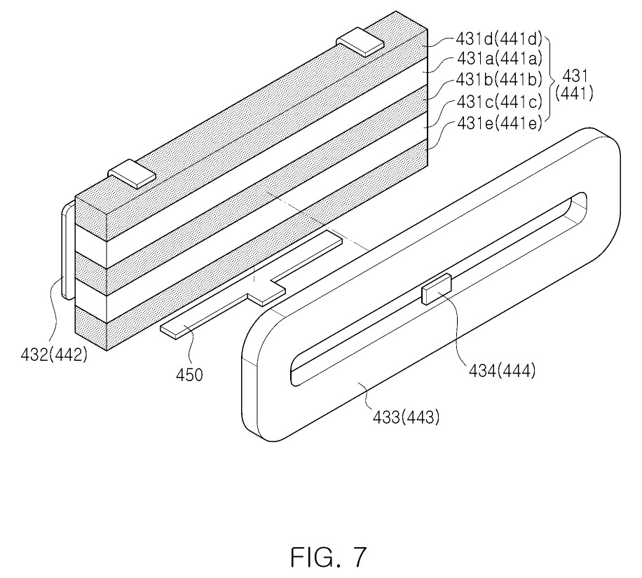

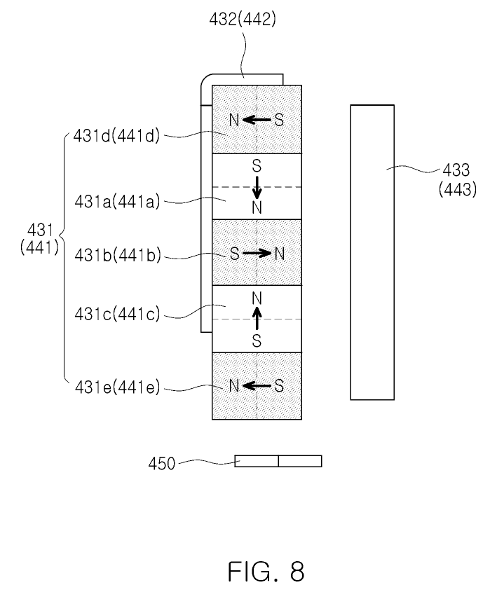

FIG. 7 is a perspective view of an image stabilization actuator according to a second embodiment, and FIG. 8 is a side view of an image stabilization actuator according to the second embodiment.

Referring to FIG. 7, the first magnet 431 and the second magnet 441 may each include five sub-magnets divided in the longitudinal axis (length) direction of the first coil 433 and the second coil 443. For example, the first magnet 431 and the second magnet 441 may include first to third sub-magnets 431a, 431b, 431c, 441a, 441b, and 441c and may further include fourth sub-magnets 431d and 441d and fifth sub-magnets 431e and 441e.

In an embodiment, the fourth sub-magnets 431d and 441d may be disposed on the upper side of the first sub-magnets 431a and 441a, and the fifth sub-magnets 431e and 441e may be disposed on the lower side of the third sub-magnets 431c and 441c. The first and second magnets 431 and 441 may be in the form in which the fourth sub-magnets 431d and 441d, the first sub-magnets 431a and 441a, the second sub-magnets 431b and 441b, the third sub-magnets 431c and 441c, and the fifth sub-magnets 431e and 441e are sequentially disposed along the short axis direction of the first and second coils 433 and 443.

In an embodiment, the fourth and fifth sub-magnets 431d, 431e, 441d and 441e may be magnetized in the same direction, and may be different from the magnetization direction of the first to third sub-magnets 431a, 431b, 431c, 441a, 441b, and 441c. For reference, the magnetization directions of the first to third sub-magnets 431a, 431b, 431c, 441a, 441b, and 441c are the same as in the first embodiment described above.

The fourth and fifth sub-magnets 431d, 431e, 441d and 441e may be magnetized in a direction in which the first and second magnets 431 and 441 and the first and second coils 433 and 443 face each other, and may have the magnetization directions opposite to that of the second sub-magnets 431b and 441b. For example, referring to FIG. 8, the second sub-magnets 431b and 441b may have an S-pole on one surfaces thereof facing the back yokes 432 and 442 and an N-pole on one surfaces thereof facing the first and second coils 433 and 443, while the fourth and fifth sub-magnets 431d, 431e, 441d and 441e may have an N-pole on one surfaces thereof facing the back yokes 432 and 442 and an S-pole on one surfaces facing the first and second coils 433 and 443.

In an embodiment, the second sub-magnets 431b and 441b may form a magnetic field by interacting with the magnets disposed on the upper side of the second sub-magnets 431b and 441b and the magnets disposed on the lower side of the second sub-magnets 431b and 441b, respectively. For example, the second sub-magnets 431b and 441b may form a closed curve with the first sub-magnets 431a and 441a and the fourth sub-magnets 431d and 441d provided on the upper side of the second sub-magnets 431b and 441b, and similarly, may form a closed curve with the third sub-magnets 431c and 441c and the fifth sub-magnets 431e and 441e provided on the lower side of the second sub-magnets 431b and 441b. In an embodiment, when current is applied to the first and second coils 433 and 443, the magnetic fields of the first and second magnets 431 and 441 are intensively formed between the first and second magnets 431 and 441 and the first and second coils 433 and 443, and leakage of the magnetic fields to the opposite sides may be significantly reduced.

According to an embodiment, the ratio of the sub-magnets on one side of the first and second magnets 431 and 441 facing the first and second coils 433 and 443 may be approximately equal, or the ratio of the second sub-magnets 431b and 441b may be the largest.

Meanwhile, even if the first to fifth sub-magnets 431a, 431b, 431c, 431d, 431e, 441a, 441b, 441c, 441d and 441e are magnetized in opposite directions, the effect is the same.

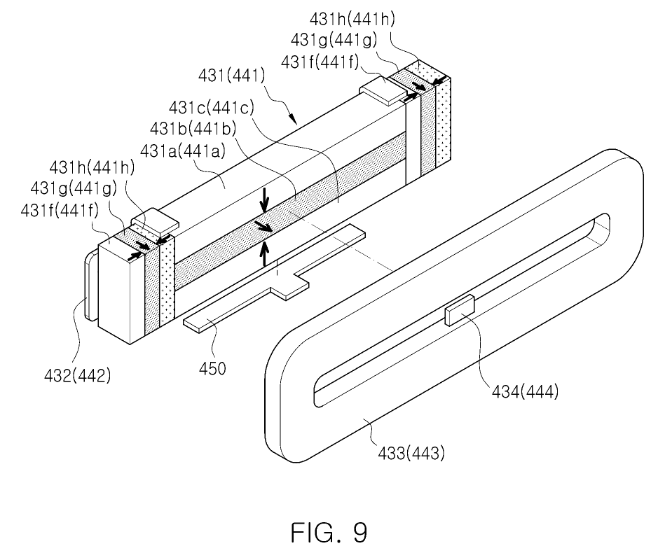

FIG. 9 is a perspective view of an image stabilization actuator according to the third embodiment.

Referring to FIG. 9, the first magnet 431 and the second magnet 441 may be provided in a form in which both ends thereof in the longitudinal axis (length) direction of the first coil 433 and the second coil 443 in the first embodiment described above are divided in the short axis (height) direction of the first and second coils 433 and 443, respectively.

In an embodiment, the first and second magnets 431 and 441 include first to third sub-magnets 431a, 431b, 431c, 441a, 441b, and 441c divided in the longitudinal axis direction of the first and second coils 433 and 443, and may further include 1-1 sub-magnets 431f and 441f, 2-1 sub-magnets 431g and 441g, and 3-1 sub-magnets 431h and 441h divided in the short axis direction of the first and second coils 433 and 443 on both ends thereof in the longitudinal direction of the first to third sub-magnets 431a, 431b, 431c, 441a, 441b, and 441c, respectively.

The first to third sub-magnets 431a, 431b, 431c, 441a, 441b, and 441c may approximately face the longitudinal axis portion of the first and second coils 433 and 443, and the 1-1 to 3-1 sub-magnets 431f, 431g, 431h, 441f, 441g and 441h may approximately face the short axis portion of the first and second coils 433 and 443.

The 1-1 to 3-1 sub-magnets 431f, 431g, 431h, 441f, 441g and 441h may be sequentially disposed in the longitudinal axis direction of the first and second coils 433 and 443, for example, from the left to the right in the drawing.

In the embodiment, the magnetization directions of the first to third sub-magnets 431a, 431b, 431c, 441a, 441b, and 441c may be different from each other, and since their magnetization directions are the same as those of the first embodiment described above, further description thereof may be omitted here.

In addition, in the embodiment, the magnetization directions of the 1-1 to 3-1 sub-magnets 431f, 431g, 431h, 441f, 441g and 441h may be different from each other (see arrow direction).

The 2-1 sub-magnets 431g and 441g may be magnetized in a direction perpendicular to one surface of the first and second coils 433 and 443 facing the first and second magnets 431 and 441 (or in a direction in which the first and second magnets 431 and 441 and the first and second coils 433 and 443 face each other). For example, the 2-1 sub-magnets 431g and 441g may have an S-pole on one surfaces thereof facing the back yokes 432 and 442, and an N-pole on one surfaces thereof facing the first and second coils 433 and 443.

The 1-1 sub-magnets 431f and 441f and the 3-1 sub-magnets 431h and 441h may be magnetized in a direction parallel to one surface of the first and second coils 433 and 443 facing the first and second magnets 431 and 441, for example, in the direction of the longitudinal axis of the first and second coils 433 and 443. At this time, the magnetization direction of the 1-1 sub-magnets 431f and 441f and the magnetization direction of the 3-1 sub-magnets 431h and 441h may be opposite to each other. For example, the 1-1 sub-magnets 431f and 441f may be provided with an S-pole and an N-pole on the left and right, and the 3-1 sub-magnets 431h and 441h may be provided with an N-pole and an S-pole on the left and right.

In the embodiment, the second sub-magnets 431b and 441b divided in the longitudinal axis direction and the 2-1 sub-magnets 431g and 441g divided in the short axis direction are all set to have magnetic fluxes input and output in a direction facing the first and second coils 433 and 443. On the other hand, the first and third sub-magnets 431a, 431c, 441a and 441c divided in the longitudinal axis direction and the 1-1 and 3-1 sub-magnets 431f, 431h, 441f and 441h divided in the short axis direction may have magnetization directions that are perpendicular to each other. For example, their magnetization directions may be perpendicular to the direction of current flowing in the longitudinal axis and short axis portions of the first and second coils 433 and 443 facing the same.

According to an embodiment, the 1-1 to 3-1 sub-magnets 431f, 431g, 431h, 441f, 441g and 441h provided on both longitudinal sides of the first and second magnets 431 and 441 may interact with each other to form a magnetic field having a similar shape to that of the first to third sub-magnets 431a, 431b, 431c, 441a, 441b, and 441c. Accordingly, the driving force generated by the first and second magnets 431 and 441 and the first and second coils 433 and 443 may be significantly increased.

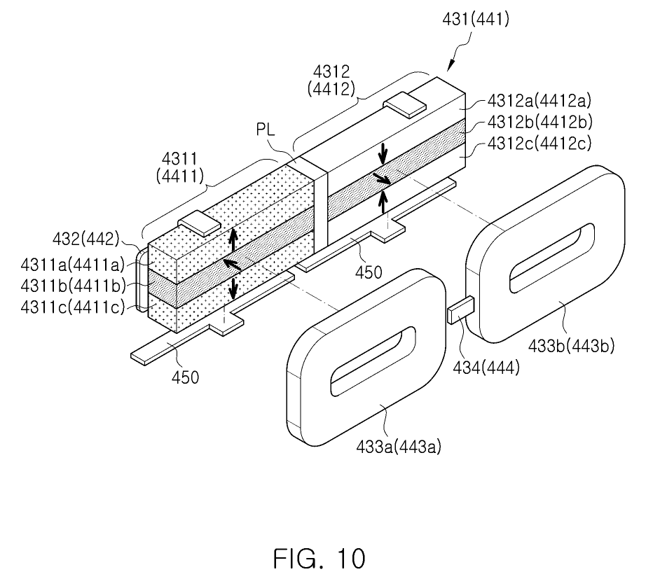

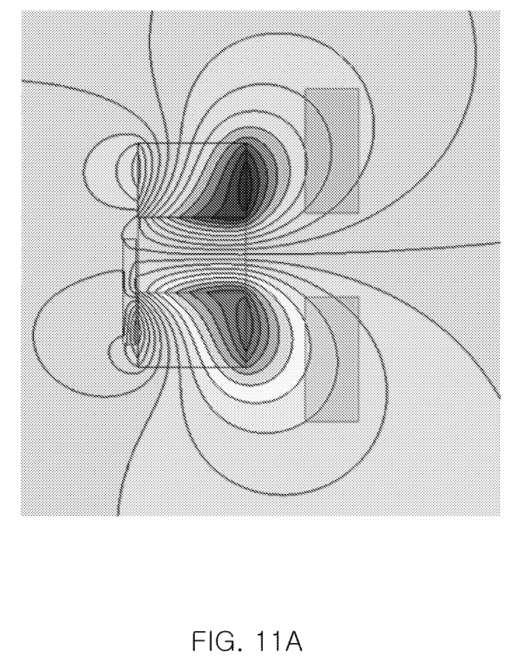

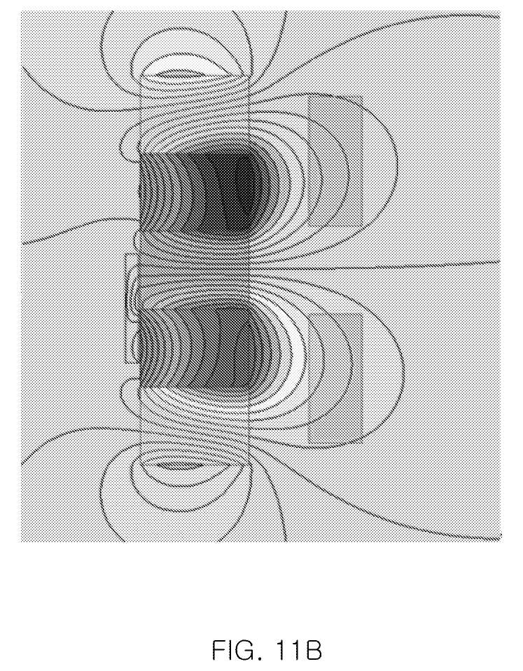

FIG. 10 is a perspective view of an image stabilization actuator according to the fourth embodiment.

Referring to FIG. 10, the image stabilization actuator according to the fourth embodiment may include one magnet and multiple coils. For example, the first and second magnets 431 and 441 may each face multiple coils, for example, two coils 433a and 433b, and 443a and 443b, respectively.

According to the embodiment, the first magnet 431 and the second magnet 441 may be provided in a form polarized in the longitudinal direction. For example, the first and second magnets 431 and 441 may include first portions 4311 and 4411 that are disposed on one side based on a (polarization) boundary (PL) and second portions 4312 and 4412 that are disposed on the other side.

The first portion 4311 and the second portion 4312 of the first magnet 431 may be one-to-one opposed to the two coils 433a and 433b constituting the first coil 433, respectively. Similarly, the first portion 4411 and the second portion 4412 of the second magnet 441 may be one-to-one opposed to the two coils 443a and 443b constituting the second coil 443.

The first portions 4311 and 4411 and the second portions 4312 and 4412 of the first and second magnets 431 and 441 may include first to third sub-magnets that are sequentially disposed in the short axis (height) direction of the first and second coils 433 and 443, respectively.

Referring to FIG. 10, the sub-magnets of the first portions 4311 and 4411 and the sub-magnets of the second portions 4312 and 4412 may be magnetized in opposite directions (see arrow directions). For example, the first to third sub-magnets 4311a, 4311b, 4311c, 4411a, 4411b and 4411c of the first portions 4311 and 4411 and the first to third sub-magnets 4312a, 4312b, 4312c, 4412a, 4412b and 4412c of the second portions 4312 and 4412 may have the same magnetization direction as the embodiments illustrated in FIGS. 4 and 6 (or vice versa).

In this case, the direction of the magnetic field formed in the first portions 4311 and 4411 and the direction of the magnetic field formed in the second portions 4312 and 4412 may be opposite to each other. Therefore, the coils facing the first portions 4311 and 4411 and the second portions 4312 and 4412 may be separately disposed and controlled.

In addition, referring to FIG. 10, the second yoke 450 may include a yoke facing the first portions 4311 and 4411 of the first and second magnets 431 and 441 and a yoke facing the second portions 4312 and 4412 of the first and second magnets 431 and 441, respectively.

The image stabilization actuator according to the present embodiments has a magnetic field concentrated between the magnets 431 and 441 and the coils 433 and 443, so that the driving sensitivity increases and the shaking may be precisely corrected. In addition, since the driving efficiency is improved by concentrating the magnetic field, the camera module may be miniaturized under the assumption that the same driving force is maintained.

As set forth above, according to embodiments, image stabilization performance of a camera module may be improved. In addition, miniaturization of the camera module may be obtained under the assumption that the same driving force is maintained.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing;
a lens module accommodated in the housing and comprising a plurality of lenses arranged in an optical axis direction; and
an image stabilization actuator comprising a magnet and a coil disposed to face each other and configured to provide driving force to move the lens module in a direction perpendicular to an optical axis,
wherein the magnet comprises a first sub-magnet, a second sub-magnet, and a third sub-magnet disposed in sequence in a short axis direction of the coil and having different magnetization directions.

2. The camera module of claim 1, wherein the second sub-magnet has a magnetization direction parallel to a direction facing the coil, and
wherein the first sub-magnet and the third sub-magnet disposed on one side and the other side of the second sub-magnet based on the short axis direction of the coil have a magnetization direction parallel to the short axis direction of the coil.

3. The camera module of claim 2, wherein the magnet further comprises a fourth sub-magnet disposed on a side of the first sub-magnet and a fifth sub-magnet disposed on a side of the third sub-magnet in the short axis direction of the coil,
wherein the fourth sub-magnet and the fifth sub-magnet have a magnetization direction parallel to the direction facing the coil.

4. The camera module of claim 3, wherein the fourth sub-magnet and the fifth sub-magnet have magnetization directions opposite to that of the second sub-magnet.

5. The camera module of claim 1, wherein the second sub-magnet is longer than the first sub-magnet and the third sub-magnet in the short axis direction of the coil.

6. The camera module of claim 1, wherein the magnet further comprises a 1-1 sub-magnet, a 2-1 sub-magnet, and a 3-1 sub-magnet sequentially disposed on both sides of the first sub-magnet, the second sub-magnet, and the third sub-magnet in a longitudinal axis direction of the coil and having different magnetization directions.

7. The camera module of claim 6, wherein the first sub-magnet, the second sub-magnet, and the third sub-magnet have lengths in the longitudinal axis direction of the coil, and
wherein the 1-1 sub-magnet, the 2-1 sub-magnet, and the 3-1 sub-magnet have lengths in the short axis direction of the coil.

8. The camera module of claim 6, wherein the 2-1 sub-magnet has a magnetization direction parallel to the direction facing the coil, and
wherein the 1-1 sub-magnet and the 3-1 sub-magnet disposed on one side and the other side of the 2-1 sub-magnet based on the longitudinal axis direction of the coil have magnetization directions parallel to the longitudinal axis direction of the coil.

9. The camera module of claim 1, wherein a surface of the magnet facing the coil comprises a first portion disposed on one side based on a boundary and a second portion disposed on the other side, and
wherein the coil comprises a plurality of coils facing the first portion and the second portion, respectively.

10. The camera module of claim 9, wherein the first portion and the second portion comprise the first sub-magnet, the second sub-magnet, and the third sub-magnet,
wherein the first sub-magnet, the second sub-magnet and the third sub-magnet of the first portion have magnetization directions opposite to those of the first sub-magnet, the second sub-magnet, and the third sub-magnet of the second portion.

11. The camera module of claim 1, further comprising a back yoke disposed on an opposite side to the coil based on the magnet.

12. The camera module of claim 1, wherein the magnet is disposed on the lens module, and the coil is disposed on the housing.

13. The camera module of claim 1, further comprising:
a carrier accommodated in the housing and accommodating the lens module;
a ball member disposed between the lens module and the carrier, and guiding movement of the lens module; and
a pulling yoke disposed on the carrier to face the magnet in the optical axis direction.

14. The camera module of claim 1, wherein the lens module comprises:
a lens barrel having the plurality of lenses; and
a lens holder to which the lens barrel is coupled and on which the magnet is disposed.

15. The camera module of claim 1, wherein the image stabilization actuator comprises a first image stabilization actuator configured to provide a driving force to move the lens module in a first direction and a second image stabilization actuator configured to provide a driving force to move the lens module in a second direction, perpendicular to the first direction, and
wherein the first image stabilization actuator and the second image stabilization actuator are perpendicularly disposed to each other.
